(19) United States
(12) Patent Application Publication
(10) Pub. No.: US 2025/0242603 A1
(43) Pub. Date: Jul. 31, 2025

(54) PRINTING APPARATUS, AND CONTROL METHOD THEREOF

(71) Applicant: CANON KABUSHIKI KAISHA, Tokyo (JP)

(72) Inventors: SERENA SAITO, Kanagawa (JP); SATOSHI WADA, Tokyo (JP); NAOKO BABA, Kanagawa (JP); TAKESHI YAZAWA, Kanagawa (JP); JUMPEI JOGO, Tokyo (JP); SHINGO NISHIOKA, Kanagawa (JP); KEIJI KURIYAMA, Saitama (JP)

(21) Appl. No.: 19/040,285

(22) Filed: Jan. 29, 2025

(30) Foreign Application Priority Data
Jan. 31, 2024 (JP) 2024-013299

(51) Int. Cl. B41J 2/51; B41J 2/15; B41J 2/21; B41J 11/48

(52) U.S. Cl. CPC B41J 2/512; B41J 2/15; B41J 2/2103; B41J 2/2114; B41J 11/485

(57) ABSTRACT

One aspect of the invention is a printing apparatus, comprising a printhead including first and second nozzle arrays, and print control means for performing printing by driving the printhead while reciprocally moving it as a serial head, wherein the first nozzle array discharges a color ink, the second nozzle array discharges a reaction liquid, for each of a forward path and a backward path, an adjustment pattern is formed by overlaying a pattern of the reaction liquid and a pattern of the color ink, and, in a case of forming the adjustment pattern in the backward path, an underlying pattern is further formed by the second nozzle array in a preceding forward path.

### BACKGROUND OF THE INVENTION

### Field of the Invention

The present invention mainly relates to an inkjet printing apparatus.

### Description of the Related Art

Some inkjet printing apparatuses discharge color inks and additionally discharge a reaction liquid that reacts with the color inks discharged to a print medium (see Japanese Patent Laid-Open No. 2001-138494). When the reaction liquid reacts with a color ink, the color ink can be fixed on the print medium. The discharge position of the color ink and the discharge position of the reaction liquid are required to substantially match each other on the print medium. Since the reaction liquid is typically colorless and transparent, a technique for appropriately adjusting the discharge position of the reaction liquid is generally demanded.

In a case of a so-called serial head that is a printhead configured to perform printing while reciprocally moving on a print medium, the discharge position of the reaction liquid may vary between the forward path and the backward path of the printhead. Furthermore, which one of the color ink and the reaction liquid is discharged first to the print medium also changes between the forward path and the backward path. Hence, there is demanded a technique capable of relatively easily implementing appropriate adjustment of the discharge position of the reaction liquid.

### SUMMARY OF THE INVENTION

The present invention relatively easily implements adjustment of the discharge position of a reaction liquid in an inkjet printing apparatus including a serial head.

One of the aspects of the present invention provides a printing apparatus comprising: a printhead including a first nozzle array and a second nozzle array; and a print control unit configured to perform printing on a print medium by driving the printhead while reciprocally moving the printhead as a serial head, wherein the first nozzle array is configured to discharge a color ink, the second nozzle array is configured to discharge a reaction liquid that reacts with the color ink and fixes the color ink on the print medium, and when a moving direction of the printhead in which the second nozzle array is located on a downstream side with respect to the first nozzle array is defined as a forward path, and an opposite direction is defined as a backward path, the print control unit executes first drive control of driving the printhead such that for each of the forward path and the backward path of the printhead, an adjustment pattern that is configured to adjust a discharge position and is formed by overlaying a pattern of the reaction liquid and a pattern of the color ink is formed, and when forming the adjustment pattern in the backward path of the printhead, an underlying pattern is further formed by the second nozzle array in a preceding forward path.

Further features of the present invention will become apparent from the following description of exemplary embodiments (with reference to the attached drawings).

### BRIEF DESCRIPTION OF THE DRAWINGS

FIG. 1 is an overall perspective view of a printing apparatus according to the embodiment;

FIG. 2 is a sectional schematic view showing the internal configuration of the printing apparatus;

FIGS. 3A and 3B are schematic views showing an example of the configuration of an optical sensor;

FIG. 4 is a schematic view showing the orifice surface of a printhead;

FIG. 5 is a block diagram for explaining the control system of the printing apparatus;

FIGS. 6A, 6B, and 6C are schematic views showing examples of sub-patterns each forming an adjustment pattern;

FIGS. 7A, 7B, 7C, and 7D are schematic views showing examples of the dot densities of the sub-patterns;

FIG. 8 is a schematic view showing an example of a detection result by the optical sensor;

FIG. 9 is a schematic view showing an example of a detection result by the optical sensor;

FIG. 10 is a schematic view showing an example of an adjustment pattern for a forward path;

FIG. 11 is a schematic view showing an example of an adjustment pattern for a backward path;

FIGS. 12A and 12B are schematic views showing a reference example of a method of printing an adjustment pattern;

FIGS. 13A and 13B are schematic views showing the outline of a first example of the method of printing an adjustment pattern;

FIG. 14 is a schematic view showing details of the first example of the method of printing an adjustment pattern;

FIGS. 15A and 15B are schematic views showing the outline of a second example of the method of printing an adjustment pattern;

FIG. 16 is a schematic view showing details of the second example of the method of printing an adjustment pattern;

FIG. 17 is a schematic view showing details of a third example of the method of printing an adjustment pattern;

FIG. 18 is a flowchart showing a method of correcting a position deviation of a reaction liquid;

FIG. 19 is a schematic view showing examples of adjustment patterns used to evaluate the position deviation of the reaction liquid;

FIG. 20 is a flowchart showing a method of correcting a position deviation of a reaction liquid; and

FIG. 21 is a flowchart showing a method of correcting a position deviation of a reaction liquid.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### Configuration of Printing Apparatus

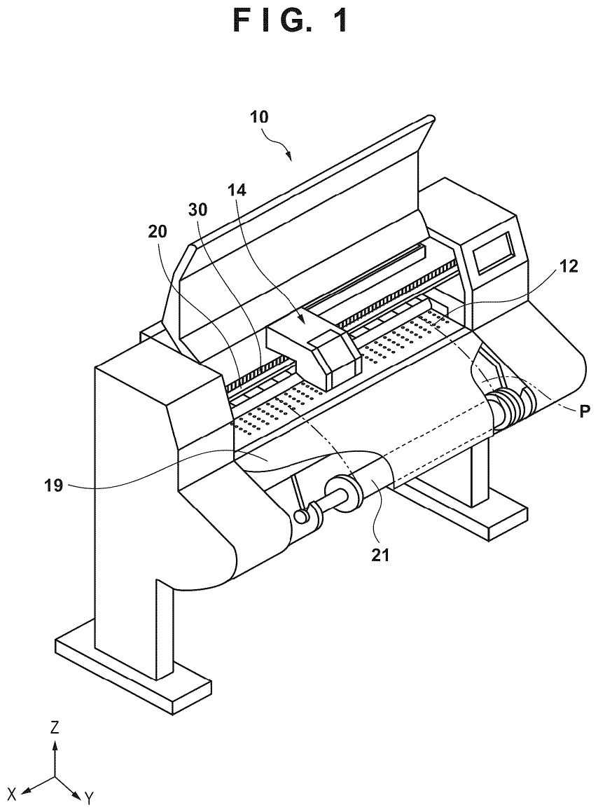

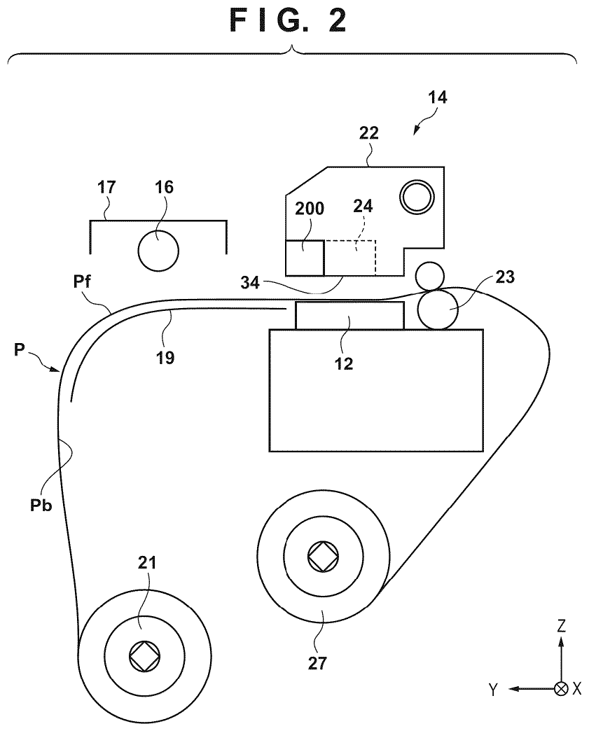

FIG. 1 is an overall perspective view showing an example of a printing apparatus 10 according to the embodiment. FIG. 2 is a sectional schematic view showing the internal configuration of the printing apparatus 10.

The printing apparatus 10 is a so-called a serial scan type that performs printing while conveying a print medium P in the apparatus main body and reciprocally moving/scanning a printhead 24 in a direction crossing the conveyance direction. The printhead 24 is expressed as a serial head. Printing is performed by an inkjet method, and is performed by discharging ink to the print medium P and forming an image. Note that the concept of an image includes not only characters, numbers, symbols, graphics, and photographs but also spaces formed therebetween.

In FIGS. 1 and 2 and other drawings to be described later, the widthwise direction of the printing apparatus 10 is the X direction, the depth direction is the Y direction, and the height direction is the Z direction. The X direction corresponds to the scanning direction of the printhead 24, and the Y direction corresponds to the conveyance direction of the print medium P. In the following explanation, “+” or “−” is added to discriminate between one direction and the other direction of each of the X to Z directions. For example, one direction (the direction on the downstream side) of the X direction is expressed as “+X direction”, and the other direction (the direction on the upstream side) of the X direction is expressed as “−X direction”.

The printing apparatus 10 includes a platen 12 that supports the print medium P conveyed in the apparatus main body, and a printing unit 14 that performs printing on the print medium P supported by the platen 12. Also, the printing apparatus 10 includes a heating unit 16 that heats a print surface Pf of the print medium P (to be sometimes simply referred to as a “printed product” hereinafter) that has undergone printing by the printing unit 14.

A conveyance unit or conveyance mechanism that conveys the print medium P sequentially draws/unwinds the print medium P from a roll sheet 27 formed by winding the sheet-shaped print medium P and feeds the print medium P by a conveyance roller 23 driven by a conveyance motor (not shown) via, for example, a gear. The fed print medium P is conveyed to the platen 12 and printed by the printing unit 14. The print medium P that has undergone printing is wound by a spool 21 again. Note that the conveyance unit is not limited to this example, and another known configuration may be employed.

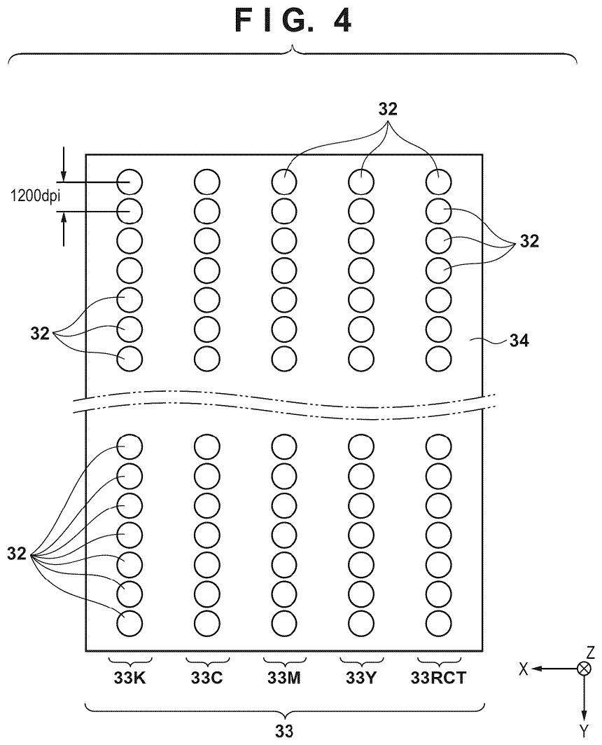

The printing unit 14 includes the printhead 24 and also includes a guide shaft 20, and a carriage 22 attached to be movable along the guide shaft 20. The guide shaft 20 is extended in the X direction, and the carriage 22 can thus reciprocally move in the X direction. The printhead 24 includes a plurality of orifices (nozzles) 32 (see FIG. 4) (to be described later) configured to discharge ink, and is detachably attached to the carriage 22 such that an orifice surface (nozzle surface) 34 (see FIG. 2) on which the plurality of orifices 32 are arrayed faces the platen 12.

With this configuration, the printhead 24 performs printing by discharging ink to the print medium P while reciprocally moving in the X direction.

Note that the moving mechanism of the carriage 22 need only use a known configuration and can be formed using, for example, a carriage motor, and a carriage belt or lead screw that transmits a driving force from the carriage motor.

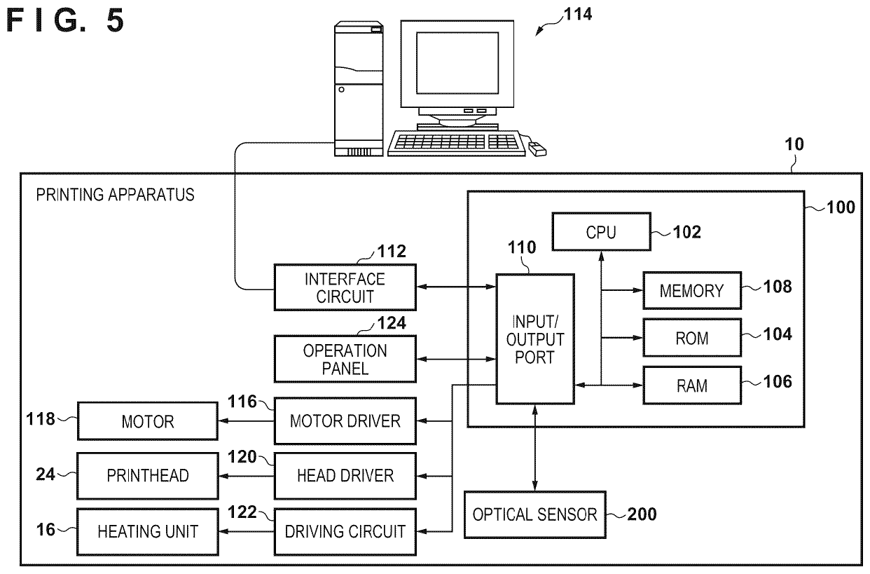

The printing apparatus 10 further includes an optical encoder 30 extending in the X direction, and the position of the printhead 24 can be controlled by a control unit 100 (see FIG. 5) based on a signal of the encoder 30.

The printhead 24 can discharge ink containing a color material, and a reaction liquid that reacts with the ink to change the viscosity of the ink to thicken or solidify the ink. Ink including a color material is color ink, and typical examples are black ink (K ink), cyan ink (C ink), magenta ink (M ink), and yellow ink (Y ink). These four color inks are pigment inks containing color materials exhibiting corresponding colors.

Hereinafter, the colors of the color inks can simply be expressed as K, C, M, and Y, but the colors and the number of color inks are not limited to the above-described four colors. Also, in this specification, the color inks may simply be expressed as ink, and the inks and the reaction liquid may be expressed as a liquid altogether.

In this embodiment, the printing unit 14 including the printhead 24 can reciprocally move at a speed of 45 inches/sec perform printing at a resolution of 1,200 dpi (dot per inch), that is, at an interval of 1/1200 inch. When printing is started, the control unit 100 moves the printhead 24 to a print start position and causes the above-described conveyance unit to convey the print medium P to a position where it can be printed by the printhead 24. After that, the control unit 100 alternately performs, based on print data, a scan printing operation of performing printing while moving the printhead 24 in the X direction and a conveyance operation of causing the conveyance unit to convey the print medium P by a predetermined amount in accordance with completion of the scan printing operation. By repeating the scan printing operation and the conveyance operation, printing on the print medium P is implemented.

A region corresponding to one scanning operation of the printhead 24 can be expressed as a unit region. In this embodiment, printing for the unit region is implemented by so-called multipass printing. That is, the printhead 24 scans the unit region of the print medium P whose conveyance is stopped a plurality of times. For example, to implement printing for the unit region by two scanning operations, the printhead 24 performs a part of printing for the unit region in the forward path (for example, scanning in the-X direction) and performs the remaining part of printing for the unit region in the backward path (for example, scanning in the +X direction).

The heating unit 16 applies heat to the print surface Pf of the print medium P that has undergone printing, thereby fixing ink added to the print surface Pf thereto. The heating unit 16 is covered with a cover 17, and the cover 17 has a protection function of protecting the heating unit 16, and a heat reflection function of reflecting heat generated by the heating unit 16 to the side of the print medium P. The heating temperature of the heating unit 16 can be set based on the fixing property of ink, the productivity of a printed product, and the like.

The heating mode of the heating unit 16 is not limited to heating from the side of the print surface Pf (see FIG. 2), and heating from a reverse surface Pb on the opposite side is also possible. In this case, the heating unit 16 is arranged, for example, on the downstream side of the platen 12 (on the side of the +Y direction) and on the lower side of a guide unit 19 (on the side of the −Z direction) that guides the print medium P after printing.

For the heating unit 16, a sheathed heater, a halogen heater, or a known noncontact heat conduction heater can be used. Another known heater such as a warm air heater may be used. Also, a plurality of heating units 16 may be provided.

As will be described later in detail, each color ink used in the printing apparatus 10 can contain a pigment, fine resin particles, and a water-soluble organic solvent. The heating unit 16 melts the fine resin particles in the ink by heating these and evaporates the water-soluble organic solvent in the ink, thereby fixing the pigment to the print medium P.

The ink containing the fine resin particles has a characteristic for improving an abrasion resistance or fixing property. Hence, the heating temperature of the heating unit 16 is preferably set to the minimum film formation temperature of the fine resin particles or more. Also, the heating temperature is required to be set to substantially evaporate a liquid component such as the water-soluble organic solvent in the ink. Hence, the heating unit 16 can be configured to form, in the conveyance direction of the print medium P, a temperature distribution capable of sufficiently ensuring heating time to sufficiently supply energy needed for the evaporation.

Although not illustrated here, the printing apparatus 10 further includes a predetermined recovery unit, and the recovery unit can recover the liquid discharge function of each orifice 32 in the printhead 24 and satisfactorily maintain the discharge state of the liquid from each orifice 32. The recovery unit can be provided near an end portion of the printhead 24 in the scanning direction (X direction), for example, adjacent to the platen 12. Examples of the recovery unit are a wiping unit that wipes the orifice surface 34, and a cap that protects the orifice surface 34, but another known recovery unit may be provided.

### Optical Sensor

As shown in FIG. 2, the printing apparatus 10 includes a reflection optical sensor 200 capable of detecting an optical characteristic on a printed product. The control unit 100 acquires an optical density (OD) value as the reflection optical characteristic on the print medium P based on the detection result of the optical sensor 200.

The installation position of the optical sensor 200 is not limited to the example shown in FIG. 2, and the optical sensor 200 may be provided on the side of the +X direction or on the side of the −X direction of the carriage 22, or may be provided on the side of the +Y direction or on the side of the −Y direction. Alternatively, the optical sensor 200 may be provided independently of the carriage 22 and arranged to be movable in the X direction, or may be extended in the X direction throughout the width of the print medium P.

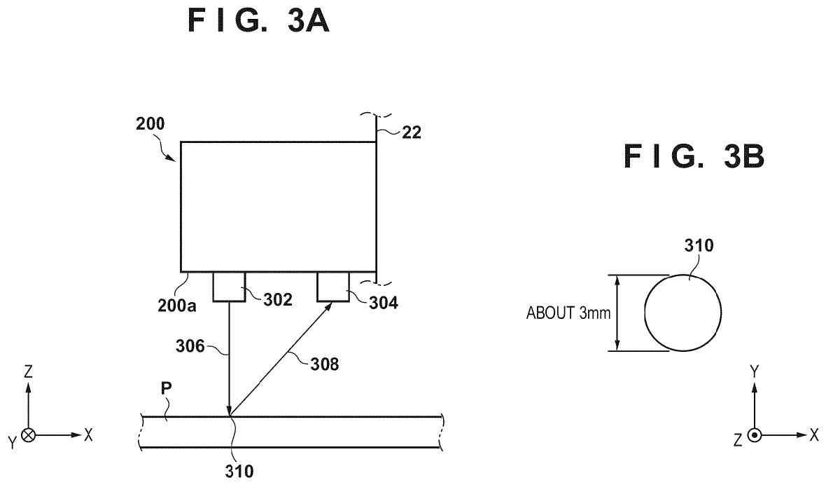

FIG. 3A is a schematic view for explaining an example of the configuration of the optical sensor 200. FIG. 3B is a schematic view showing a detection spot of the optical sensor 200.

The optical sensor 200 is fixed to the carriage 22 such that a detection region or a measurement region is located on the side of the +Y direction with respect to the orifice array (nozzle array) 33 (see FIG. 4) of the printhead 24. A lower surface 200a of the optical sensor 200 is located to match the orifice surface 34 in the Z direction, or is located on the side of the +Z direction with respect to the orifice surface 34.

The optical sensor 200 includes a light emitting unit 302 (for example, an LED) that generates visible light such as red light, green light, or blue light, and a light receiving unit 304 (for example, a photodiode) that detects the visible light. The light emitting unit 302 and the light receiving unit 304 are provided on the lower surface 200a of the optical sensor 200. The light emitting unit 302 irradiates the print medium P with light, and the light receiving unit 304 receives and detects the light reflected by the print medium P. That is, irradiation light 306 from the light emitting unit 302 is irregularly reflected by the print medium P, and reflected light 308 associated with this is detected by the light receiving unit 304. Note that the diameter of a detection spot 310 where the irradiation light 306 is irregularly reflected by the print medium P is, for example, about 3 mm.

A detection signal detected by the light receiving unit 304 as an analog signal corresponding to the light amount of the reflected light 308 is transferred to a control circuit on the electric board of the printing apparatus 10 via a wiring portion (not shown) such as a flexible cable. In the control circuit, the detection signal is converted into a digital signal by an A/D converter.

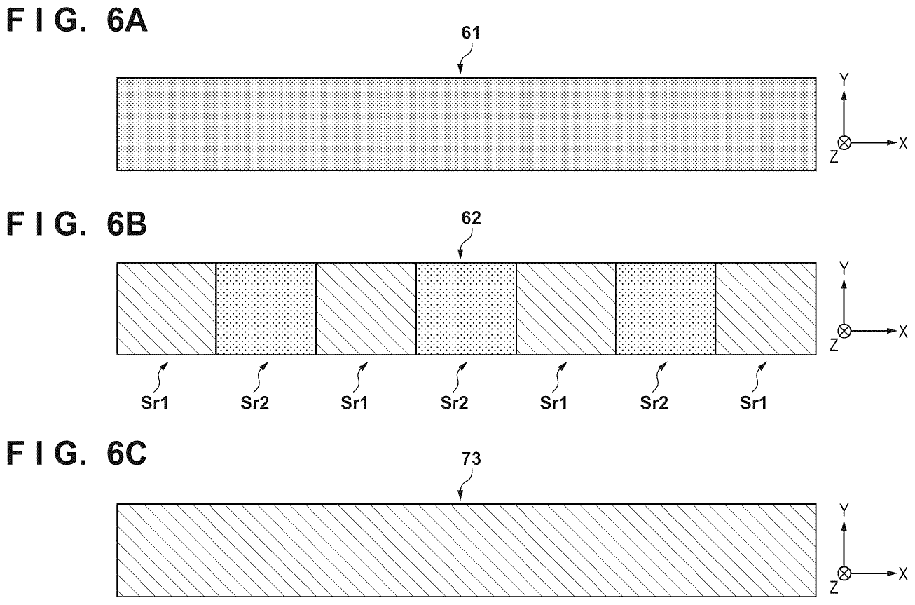

When detecting the optical characteristic of an adjustment pattern (see FIG. 6A and the like) (to be described later), conveyance of the print medium P in the Y direction and movement of the carriage 22 with the optical sensor 200 attached in the X direction are alternately executed. The optical sensor 200 detects an optical reflectance on a printed product (that is, the density of a printed pattern) while synchronizing the execution timing based on a position signal obtained by the encoder 30. For example, the reflection intensity is large/strong in a case of a white or relatively light printed pattern, and the reflection intensity is small/weak in a case of a black or relatively dark printed pattern.

### Printhead

FIG. 4 is a schematic view showing the orifice surface 34 of the printhead 24 viewed in the +Z direction. On the orifice surface 34, one or more orifice arrays 33, in each of which the plurality of orifices 32 configured to discharge a corresponding liquid are arrayed along the Y direction, are formed. Here, five orifice arrays 33K, 33C, 33M, 33Y, and 33RCT, which discharge K ink, C ink, M ink, Y ink, and a reaction liquid RCT, respectively, are formed in the X direction. Note that the array order of the five orifice arrays 33K, and the like is not limited to the example shown in FIG. 4, and the orifice arrays may be arrayed in another order.

In this embodiment, in each orifice array 33, 1,280 orifices 32 are arrayed at an interval of 1,200 dpi in the Y direction, and the discharge amount of a liquid (a color ink or a reaction liquid) discharged at once from a single orifice 32 is about 4.5 pl (picoliter). In addition, a tank (not shown) that stores a corresponding liquid is connected to each orifice array 33, and the corresponding liquid is supplied from the tank to the orifice array 33. Note that the tank may be integrated with the printhead 24, or may be detachable from the carriage 22.

### Color Ink

As a color ink, a pigment ink containing a pigment and/or a water-soluble fine resin particle ink containing no or a very small amount of pigment can typically be used. The fine resin particles adheres the print medium P and a color material to each other and improves the abrasion resistance or fixing property of a printed image. The fine resin particles can be melted by heat, and film formation of the fine resin particles and drying of the solvent in the ink are performed by the heating unit 16. In this embodiment, the fine resin particles are fine polymer particles dispersed in a liquid. The fine polymer particles may be fine resin particles (so-called self-dispersion type fine resin particle dispersion) obtained by homopolymerizing a monomer having a dissociating group or copolymerizing a plurality of kinds of monomers.

To obtain a desired characteristic, a surfactant, a defoaming agent, a preservative, a mildewproof agent, or the like may be added to the color ink. For the surfactant, a penetrant for improving the permeability of a color ink to the print medium P dedicated to inkjet can be used. In this embodiment, the surfactant is selected and adjusted such that the surface tension of each color ink is 30 dyn/cm or less, and the surface tension difference between the color inks is 2 dyn/cm or less. That is, the surface tensions of all color inks are set within the range of 28 to 30 dyn/cm.

To prevent impurity elution from constituent members that come into contact with a color ink in the printing apparatus 10 or the printhead 24, degradation of the constituent members, and/or lowering of the solubility of the pigment dispersion resin in the color ink, pH of the color ink preferably falls within the range of 7.0 to 10.0. Since each color ink used in this embodiment contains an anion-based color material, pH is stable on the alkali side, and the value falls within the range of 8.5 to 9.5.

### Reaction Liquid

The reaction liquid RCT contains a reactive component that reacts with the color material of a color ink, and the reaction liquid RCT solidifies or thickens the color ink when contacting the color ink, and fixes the color ink to the print medium P while suppressing bleeding of the color ink on the print medium P. More specifically, the reaction liquid contains a reactive component that reacts with a pigment in a color ink and coagulates or gelates the pigment and/or a reactive component that reacts with fine resin particles and insolubilizes it/these.

The reactive component is, for example, a component capable of, by the effect of an ionic group, breaking dispersion stability in a color ink when being mixed with the color ink containing a component dispersed in a liquid. An example of the reactive component is an organic acid such as glutaric acid. The content of the organic acid in the reaction liquid RCT preferably falls within the range of 3.0 mass % to 90.0 mass % with respect to the total mass of compositions in the reaction liquid RCT as a reference, and more preferably falls within the range of 5.0 mass % to 70.0 mass %. Also, a surfactant is preferably added to the reaction liquid RCT as well, like color inks.

### Execution Control of Printing Operation

FIG. 5 is a block diagram for explaining the control system of the printing apparatus 10. The control unit 100 is configured to control the whole system of the printing apparatus 10, and includes a central processing unit (CPU) 102, a read only memory (ROM) 104, a random access memory (RAM) 106, and a memory 108.

The CPU 102 performs drive control of each element of the printing apparatus 10, and processing of image data input to the printing apparatus 10 based on a predetermined program. The ROM 104 stores the program that the CPU 102 can execute. The RAM 106 stores information such as parameters and data necessary for the drive control of the printing apparatus 10. The memory 108 stores information such as adjustment patterns and mask patterns to be described later.

Also, the control unit 100 includes an input/output port 110 and is connected to an element outside the control unit 100 via the input/output port 110.

For example, the control unit 100 is connected to an interface circuit 112 via the input/output port 110, and connected to a host device 114 via the interface circuit 112. The control unit 100 is also connected, via the input/output port 110, to an operation panel 124 that can be operated by a user. The user can input desired image data to the printing apparatus 10 via the host device 114, and can also input other pieces of information necessary for printing to the printing apparatus 10 via the host device 114 and the operation panel 124.

Also, the control unit 100 is connected to a motor driver 116 via the input/output port 110, and performs drive control of a motor 118 via the motor driver 116. The motor 118 includes various kinds of motors provided in the printing apparatus 10 such as a carriage motor that moves the carriage 22, and a conveyance motor that drives the above-described conveyance unit.

The control unit 100 is also connected to a head driver 120 via the input/output port 110, and performs drive control of the printhead 24 via the head driver 120.

The control unit 100 is also connected to a driving circuit 122 via the input/output port 110, and performs drive control of the heating unit 16 via the driving circuit 122.

Furthermore, the control unit 100 is connected to the optical sensor 200 via the input/output port 110, performs drive control of the optical sensor 200, and thus detects the optical characteristic of an adjustment pattern (to be described later) on a printed product based on a signal from the optical sensor 200. In this viewpoint, it can be said that, in this embodiment, the control unit 100 and the optical sensor 200 function as a detection unit capable of detecting the optical characteristic.

When executing printing, in the control unit 100, the CPU 102 converts image data input from the host device 114 into print data and stores it in the RAM 106. More specifically, for each of RGB data corresponding to red, green, and blue, the CPU 102 acquires image data indicating 8-bit information with 256 values (0 to 255). After that, the CPU 102 performs color conversion processing of converting the image data into multivalued data corresponding to a plurality of types of inks (in this embodiment, K, C, M, and Y corresponding to color inks) in the printing apparatus 10. That is, in the color conversion processing, multivalued data indicating 8-bit information with 256 values (0 to 255) indicating the tome of each of K, C, M, and Y in each of a plurality of pixels is generated.

Next, quantization of the above-described multivalued data is executed, and the CPU 102 generates quantized data (binary data) indicating, for each pixel, 1-bit information with two values (0 or 1), which decides discharge or non-discharge of each of the K, C, M, and Y inks. As an example of quantized data generation processing, a known quantization method such as an error diffusion method, a dither method, or an index method can be used.

After that, the CPU 102 performs distribution processing of distributing the above-described quantized data to each region of one scanning operation of the printhead 24 such that the above-described multipass printing is implemented. Accordingly, print data that indicates, for each pixel, 1-bit information with two values (0 or 1), which decides discharge or non-discharge of each of the K, C, M, and Y inks, and corresponds to each scanning of the printhead 24 is generated. The distribution processing can be executed using a mask pattern indicating permission or non-permission of liquid discharge of each orifice 32 in each scanning operation.

In this way, the control unit 100 functions as a print control unit that performs desired printing based on the result of the above-described data processing, and performs drive control of the elements of the printing apparatus 10, mainly, the printing unit 14 (printhead 24) and the conveyance unit (not shown). Note that the above-described data processing may be executed at least partially by the host device 114.

### Deviation Amount of Liquid Discharge Position

With the above-described configuration, the printing apparatus 10 performs the printing operation based on print data. That is, the printhead 24 discharges a liquid while being reciprocally moved in the X direction by the carriage 22, thereby performing printing on the print medium P.

At the time of printing, the color inks and the reaction liquid are discharged in predetermined amounts in the same region. The reaction liquid thus contacts the color inks at a predetermined ratio, and this can suppress bleeding of the color inks, which conspicuously occurs particularly on the non-absorbing (or hardly absorbing) print medium P. Also, when the print medium P to which the color inks and the reaction liquid are discharged passes through the heating unit 16, the color inks are heated and dried, thereby promoting ink fixing even on the non-absorbing print medium P.

As described above, the color inks and the reaction liquid need to be discharged to the same region. Hence, the printing apparatus 10 needs to evaluate the relative deviation of the discharge position of the reaction liquid to the discharge position of each color ink and acquire the amount of the deviation. The discharge position here indicates the landing position of a droplet on the print medium P. In the following explanation, the relative deviation of the discharge position of a liquid will sometimes simply be referred to as a “position deviation”. Also, the amount will sometimes simply be referred to as a “position deviation amount”. Particularly, in this configuration in which the liquid is discharged while the carriage 22 reciprocally moves in the X direction, it is necessary to acquire the position deviation amount in the X direction.

Acquisition processing for acquiring such a position deviation amount can be executed by, for example, the user instructing, via the host device 114 or the operation panel 124, to start the acquisition processing. After that, based on the acquired position deviation amount, a correction value for correcting the liquid discharge timing can be calculated or specified by, for example, the control unit 100. The printing operation is performed by correcting the liquid discharge timing based on the thus calculated correction value and adjusting the discharge position.

### Adjustment Pattern

Adjustment of the discharge position of a color ink (mainly, a series of operations of acquiring the above-described position deviation amount, calculating the correction value for correcting the position deviation amount, and incidentally correcting the discharge timing) can be executed using a known adjustment pattern. This can be relatively easily implemented by, for example, detection by the optical sensor 200 or visual observation of the user.

On the other hand, as will be described later in detail, adjustment of the discharge position of the reaction liquid is performed by printing or forming a pattern of a color ink and a pattern of the reaction liquid in an overlaid state, and detecting the difference of the degree of reaction by the reaction liquid using the optical sensor 200 or visually observing it by the user.

However, the reaction liquid is generally colorless and transparent, and its discharge position may vary between the forward path (for example, scanning in the −X direction) and the backward path (for example, scanning in the +X direction). In addition, as will be described later in detail, when performing the adjustment for the reaction liquid, the pattern of the reaction liquid needs to be printed before the pattern of the color ink. For these reasons, the adjustment for the reaction liquid is generally difficult as compared to a case of a color ink.

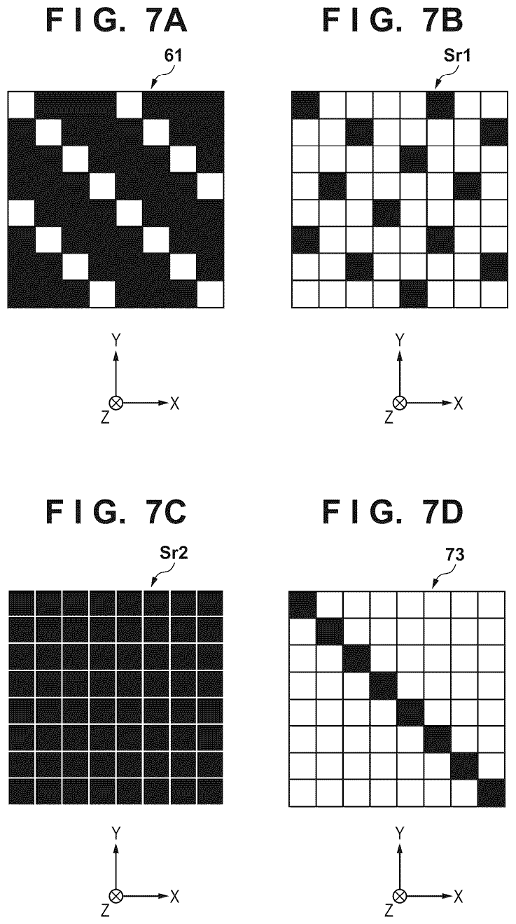

FIGS. 6A to 6C show examples of sub-patterns each forming an adjustment pattern to be described later. FIGS. 7A to 7D show, as examples of detailed patterns of the sub-patterns, partially enlarged views of a region of a total of 64 pixels including 8 pixels in the X direction and 8 pixels in the Y direction.

FIG. 6A shows a sub-pattern 61 formed by one of the color inks. In this embodiment, the sub-pattern 61 is formed by K ink but may be formed by another color ink. As shown in FIG. 7A, the sub-pattern 61 is printed at a relatively high dot density and uniformly.

FIG. 6B shows a sub-pattern 62 formed by the reaction liquid. The sub-pattern 62 is formed by alternately arranging a region Sr1 of a relatively low dot density and a region Sr2 of a relatively high dot density. In the region Sr1 of the sub-pattern 62, as shown in FIG. 7B, printing is performed at a relatively low dot density and uniformly. Also, in the region Sr2, as shown in FIG. 7C, printing is performed at a relatively high dot density and uniformly. According to this example, in the region of a total of 64 pixels, dots of 13 pixels are discretely formed in the example shown in FIG. 7B, and dots are formed in the entire region in the example shown in FIG. 7C. However, the dot densities are relative, and the dot densities are not limited to this example.

FIG. 6C shows another sub-pattern 73 formed by the reaction liquid. As will be described later in detail, the sub-pattern 73 functions as an underlying pattern configured to appropriately implement printing of an adjustment pattern. As shown in FIG. 7D, the sub-pattern 73 is printed at a relatively low dot density and uniformly.

Note that “uniform” here includes that the dot density is not locally biased in evaluation of a wide region, and for the difference of the degree of reaction by the reaction liquid, detection by the optical sensor 200 and/or visual observation of the user is not impeded. Hence, a uniform pattern need not always be a dot pattern according to strict regularity.

Also, for the sub-pattern 62, the two regions Sr1 and Sr2 have been exemplified for easier understanding. Regions adjacent to each other need only have different dot densities, and the number of types of regions need only be two or more.

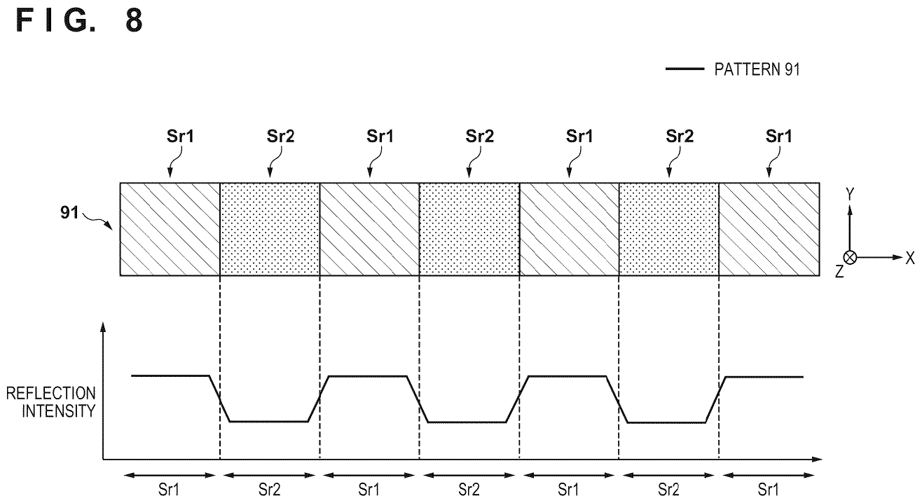

Consider a case where an adjustment pattern 91 is printed by overlaying, of the above-described sub-patterns, the uniform sub-pattern 61 of K ink and the sub-pattern 62 in which the regions Sr1 and Sr2 are alternately arranged, as shown in FIG. 8. When the adjustment pattern 91 is printed by overlaying the sub-patterns 61 and 62, the reaction liquid of the sub-pattern 62 reacts with the K ink of the sub-pattern 61. At this time, since the degree of reaction in the region Sr2 of the relatively high dot density is larger than that in the region Sr1 of the relatively low dot density, the optical characteristic changes between the regions Sr1 and Sr2, more specifically, the reflection intensity in the region Sr1 is higher than in the region Sr2.

The change of the reflection intensity between the regions Sr1 and Sr2 indicates the boundary between the regions Sr1 and Sr2, and can be detected by the above-described optical sensor 200 (see FIG. 3), but can also be visually recognized by visual observation of the user.

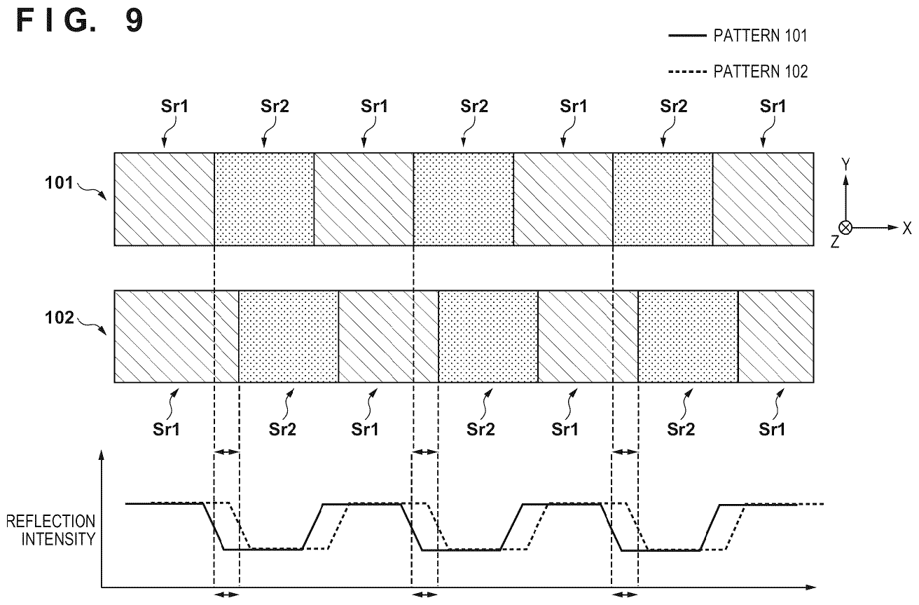

FIG. 9 shows adjustment patterns 101 and 102 considering the forward path (for example, scanning in the −X direction) and the backward path (for example, scanning in the +X direction), like the adjustment pattern 91 in FIG. 8. For example, the adjustment pattern 101 is printed in the forward path, and the adjustment pattern 102 is printed in the backward path. As described above or as shown in FIG. 9, the discharge position of the reaction liquid can vary between the forward path and the backward path. The position deviation amount can be acquired, based on the change of the reflection intensity between the regions Sr1 and Sr2, by detection of the optical sensor 200 (or by visual observation of the user). A correction value is calculated based on the thus acquired position deviation amount, and the discharge timing of the reaction liquid in one (for example, the backward path) of the forward path and the backward path can be corrected based on the correction value such that it matches the discharge timing of the reaction liquid in the other (for example, the forward path).

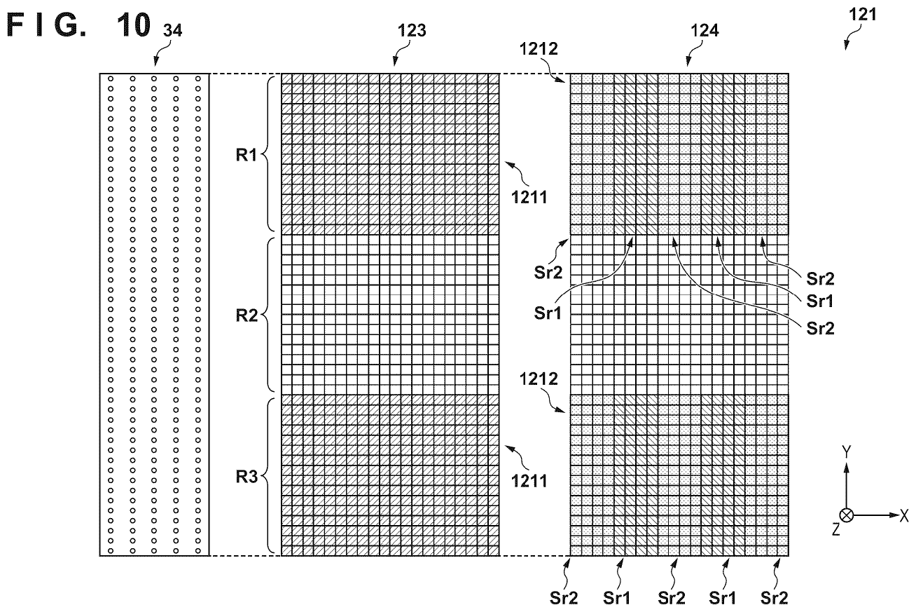

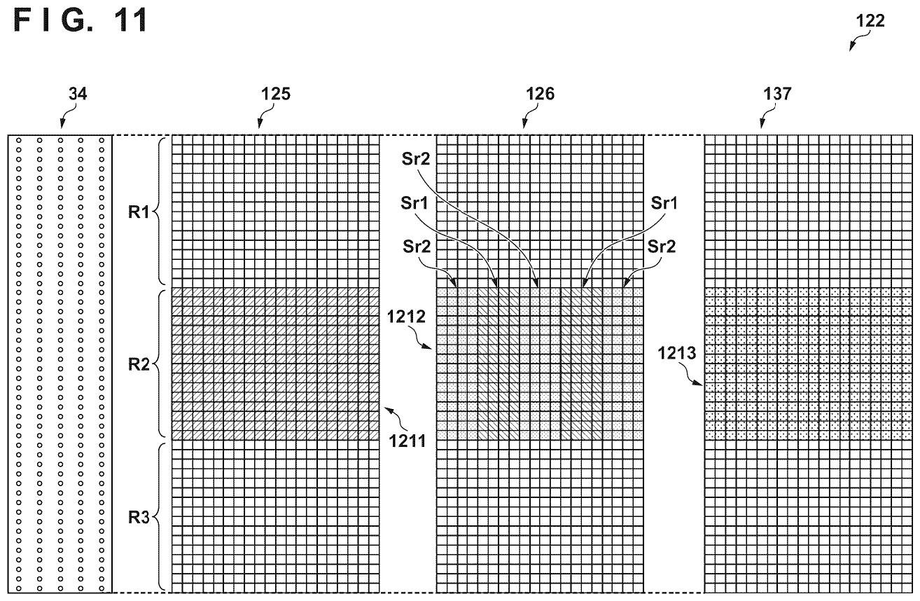

FIGS. 10 and 11 each show an example of a method of printing or forming an adjustment pattern according to this embodiment.

FIG. 10 shows an adjustment pattern 121 for forward path when discharging the reaction liquid in the forward path. The adjustment pattern 121 is printed by some parts of the orifice arrays 33, and in this embodiment, printed by regions (regions except the center portion) of the orifice arrays 33K and 33RCT on one end side and the other end side in the Y direction. These printing regions are defined as regions R1 and R3. The adjustment pattern 121 includes a sub-pattern 123 formed by the K ink, and a sub-pattern 124 formed by the reaction liquid. The sub-pattern 123 formed by the K ink can be printed in any of the forward path and the backward path, but the sub-pattern 124 formed by the reaction liquid is printed in the forward path.

FIG. 11 shows an adjustment pattern 122 for backward path when discharging the reaction liquid in the backward path. The adjustment pattern 122 is printed by other parts of the orifice arrays 33, and in this embodiment, printed by regions of the orifice arrays 33K and 33RCT at the center in the Y direction. The printing regions are defined as regions R2. The adjustment pattern 122 includes a sub-pattern 125 formed by the K ink, and a sub-pattern 126 formed by the reaction liquid, and further includes a sub-pattern 137 formed by the reaction liquid, as will be described later in detail. The sub-pattern 125 formed by the K ink can be printed in any of the forward path and the backward path, but the sub-pattern 126 formed by the reaction liquid is printed in the backward path. Also, the sub-pattern 137 formed by the reaction liquid can be printed in any of the forward path and the backward path.

The patterns printed in the regions R1 and R3 of the sub-pattern 123 and the pattern printed in the region R2 of the sub-pattern 125 are substantially identical, and are each indicated as a pattern 1211. The pattern 1211 corresponds to the sub-pattern 61 shown in FIG. 6A.

The patterns printed in the regions R1 and R3 of the sub-pattern 124 and the pattern printed in the region R2 of the sub-pattern 126 are substantially identical, and are each indicated as a pattern 1212. The pattern 1212 is formed by alternately arranging the regions Sr1 and Sr2 and corresponds to the sub-pattern 62 shown in FIG. 6B.

The pattern printed in the region R2 of the sub-pattern 137 is indicated as a pattern 1213. The pattern 1213 corresponds to the sub-pattern 73 shown in FIG. 6C.

The regions R1 to R3 can be considered as regions obtained by dividing, in the Y direction, the unit region that is the region of one scanning operation of the printhead 24, and the above-described adjustment patterns 121 and 122 are printed in the unit region by a plurality of scanning operations of the printhead 24. The patterns 1211, 1212, and 1213 forming the adjustment patterns 121 and 122 are printed by one scanning operation (the forward path or the backward path).

### Underlying Pattern

In this embodiment in which multipass printing is performed, in a case of normal printing (a case where a printed product formed by characters, numbers, symbols, graphics, photographs, and the like is generated, and typically, a case where a desired document file is printed in accordance with an instruction from the host device 114), an operation of performing printing by discharging the reaction liquid and the color inks in the forward path and an operation of performing printing by discharging the reaction liquid and the color inks in the backward path are repeated a plurality of times in the same unit region, and most of the orifices 32 are never driven at once. For this reason, which one of the color ink and the reaction liquid is discharged first to the print medium P is generally difficult to be problematic.

On the other hand, when printing an adjustment pattern, the number of scanning operations of the printhead 24 per unit region is smaller than in normal printing, and each of the patterns 1211 and the like described above is generally printed by one scanning operation. Hence, if the pattern (for example, the pattern 1211) of the color ink is printed first at once, the droplets of the color ink may flow on the print medium P before the subsequent pattern (for example, the pattern 1212) of the reaction liquid is printed. Since this flow may damage the uniformity of the pattern of the color ink, it is difficult to appropriately print the adjustment pattern, and the position deviation amount of the reaction liquid is difficult to acquire based on the change of the reflection intensity between the regions Sr1 and Sr2.

Hence, when printing the adjustment pattern for adjusting the discharge position of the reaction liquid, the pattern of the reaction liquid needs to be printed before the pattern of the color ink.

### REFERENCE EXAMPLE

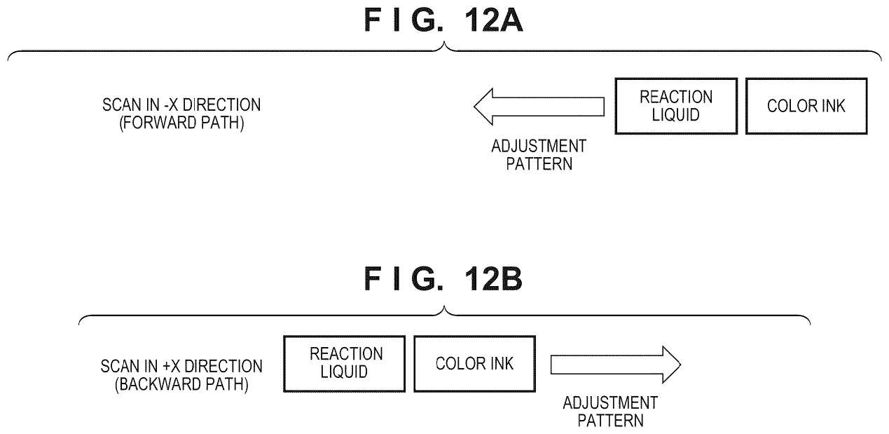

FIGS. 12A and 12B show, as a reference example, an example of a method of printing an adjustment pattern. As for the printhead 24, the orifice array 33RCT capable of discharging the reaction liquid RCT is located on the downstream side of the forward path with respect to the orifice array 33K capable of discharging the K ink.

FIG. 12A shows a state in which in the forward path, the orifice array 33RCT is driven before the orifice array 33K and, therefore, the reaction liquid RCT is discharged first to the print medium P, and the K ink is discharged after that.

FIG. 12B shows a state in which in the backward path, the orifice array 33K is driven before the orifice array 33RCT and, therefore, the K ink is discharged first to the print medium P, and the reaction liquid RCT is discharged after that.

In this reference example, since the K ink that is an example of the color ink is discharged before the reaction liquid RCT, the droplets of the color ink may flow, and it may be difficult to appropriately print the adjustment pattern, as described above.

### First Example

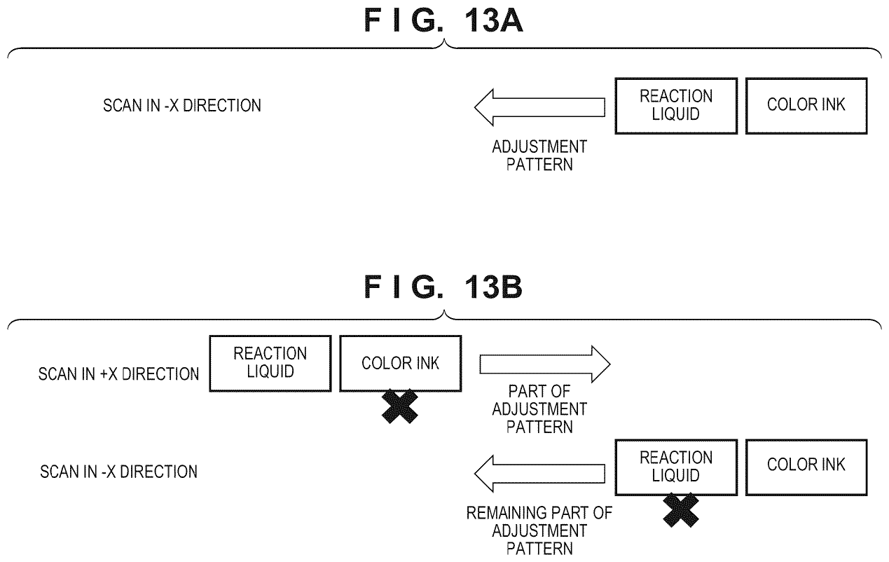

FIGS. 13A and 13B show, as a first example, another example of the method of printing an adjustment pattern, like the above-described reference example (see FIGS. 12A and 12B). FIG. 13A is the same as FIG. 12A, and a description thereof will be omitted here.

On the other hand, in FIG. 13B, the orifice array 33RCT is driven in the backward path, and the orifice array 33K is driven in the next forward path. Accordingly, the reaction liquid RCT is discharged first to the print medium P, and the K ink is discharged after that. Note that “x” in FIG. 13B indicates that driving is suppressed.

Hence, in this example, since the reaction liquid RCT is discharged before the K ink in both the forward path and the backward path, an adjustment pattern can appropriately be printed.

In the following explanation, the adjustment pattern print mode will be defined as a first print mode Md1.

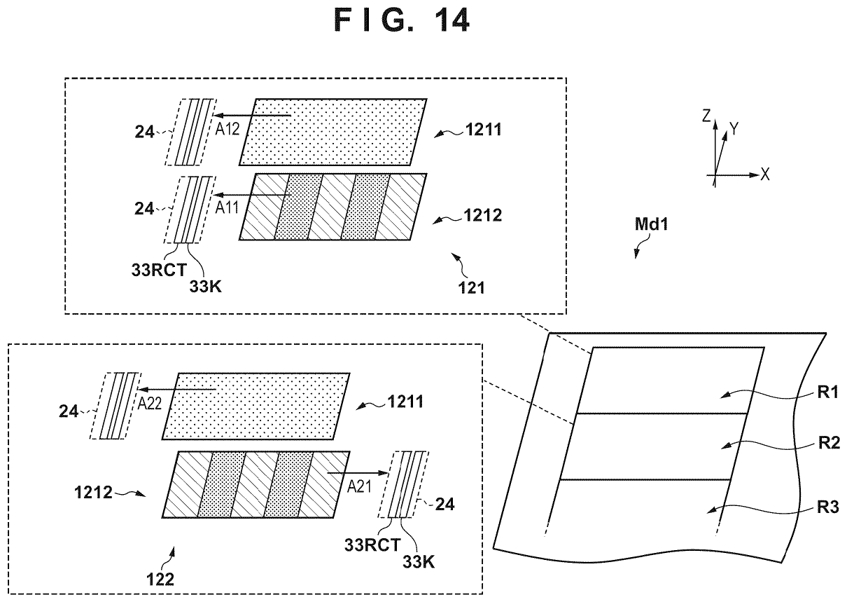

FIG. 14 is a schematic perspective view for individually explaining the adjustment pattern 121 for forward path printed in the region R1 in the first print mode Md1 and the adjustment pattern 122 for backward path printed in the region R2. Note that the region R3 is the same as the region R1, and a description thereof will be omitted here. In each enlarged schematic view, the pattern shown on the lower side is printed under the pattern shown on the upper side.

In the region R1, the pattern 1212 of the reaction liquid is printed in the forward path of the printhead 24 indicated by an arrow A11, and substantially simultaneously, the pattern 1211 of the color ink is printed in the forward path of the printhead 24 indicated by an arrow A12. Here, the arrows A11 and A12 correspond to the same one scanning operation of the printhead 24. Since the orifice array 33RCT is located on the downstream side of the forward path with respect to the orifice array 33K, the pattern 1212 is printed before the pattern 1211.

On the other hand, in the region R2, the pattern 1212 of the reaction liquid is printed in the backward path of the printhead 24 indicated by an arrow A21, and the pattern 1211 of the color ink is printed in the next forward path, as indicated by an arrow A22. Hence, in the region R2 as well, the pattern 1212 is printed before the pattern 1211.

According to the print mode Md1, in both the regions R1 and R2 (and also the region R3), the pattern 1212 of the reaction liquid is printed before the pattern 1211 of the color ink, that is, the pattern 1212 is formed under the pattern 1211. Hence, according to the print mode Md1, it is possible to prevent the droplets of the color ink of the pattern 1211 from flowing on the print medium P and appropriately print the adjustment pattern.

Printing of the pattern 1211 and the like may sequentially be performed for each of the regions R1 to R3 but may be performed simultaneously. When simultaneously performing the printing for the regions R1 to R3, it can be said that the printing can be implemented by, for example, one reciprocal motion on the backward path indicated by the arrow A21 and on the forward path indicated by the arrows A11, A12, and A22.

### Second Example

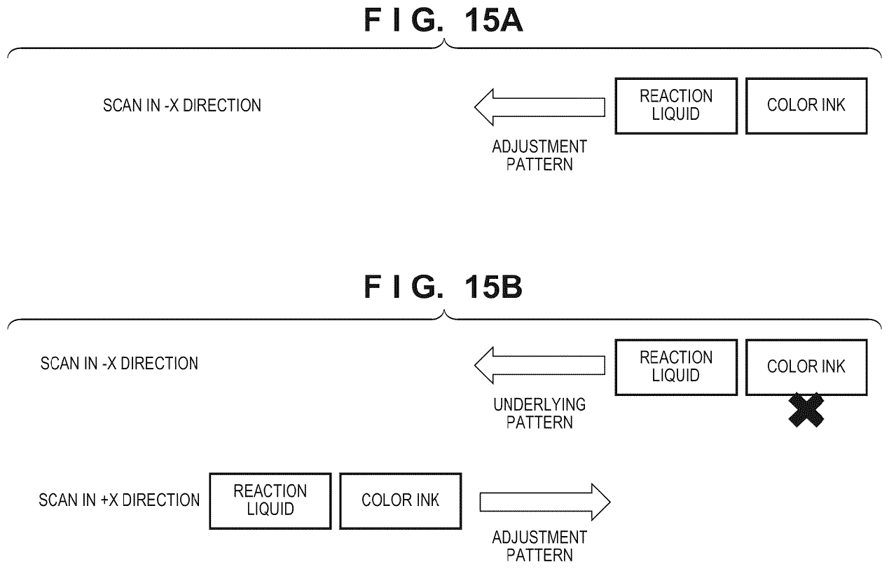

FIGS. 15A and 15B show a second example in which the flow of the droplets of the color ink can be prevented, like the above-described reference example and the first example (see FIGS. 12A and 12B and FIGS. 13A and 13B). FIG. 15A is the same as FIGS. 12A and 13A, and a description thereof will be omitted here.

On the other hand, FIG. 15B shows that the orifice arrays 33K and 33RCT are driven in the backward path, but the orifice array 33RCT is driven in the forward path before that. In the forward path, the uniform pattern 1213 of the reaction liquid is formed as an underlying pattern, and in the subsequent backward path, the pattern 1211 of the color ink and the pattern 1212 of the reaction liquid are sequentially printed.

As described above, the pattern 1213 corresponds to the sub-pattern 73 shown in FIG. 6C, and is printed at a relatively low dot density and uniformly (see FIG. 7D). It is necessary only that the pattern 1213 has a dot density capable of preventing the above-described flow, and the influence on the pattern 1211 of the color ink is suppressed as compared to the pattern 1212 of the reaction liquid. That is, as for the dot density of the pattern 1213, the change of the reflection intensity that can occur between the regions Sr1 and Sr2 due to the difference of the degree of reaction need only be detectable by the optical sensor 200 (or visually recognizable by visual observation of the user).

Referring to FIGS. 7B to 7D again in this viewpoint, the dot density of the sub-pattern 73 is preferably lower than at least the dot density of the region Sr2 of the sub-pattern 62 and further preferably lower than the dot density of the region Sr1.

In this example, the uniform pattern 1213 of the reaction liquid functions as an underlying pattern for appropriately printing an adjustment pattern formed by the patterns 1211 and 1212 to be printed after that.

In the following explanation, the adjustment pattern print mode will be defined as a second print mode Md2.

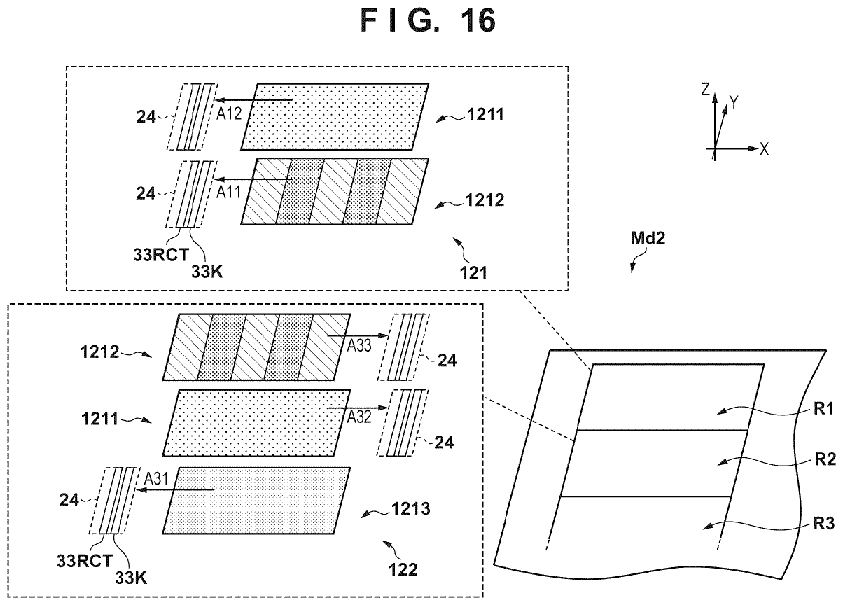

FIG. 16 is a schematic perspective view for individually explaining the adjustment pattern 121 for forward path printed in the region R1 in the print mode Md2 and the adjustment pattern 122 for backward path printed in the region R2, like the above-described first example (see FIG. 14). Note that the region R1 (and the region R3) is the same as in the first example, and a description thereof will be omitted here.

On the other hand, in the region R2, first, the uniform pattern 1213 of the reaction liquid is printed in the forward path of the printhead 24 indicated by an arrow A31. Then, in the next backward path, the pattern 1211 of the color ink is printed, as indicated by an arrow A32, and substantially simultaneously, the pattern 1212 of the reaction liquid is printed, as indicted by an arrow A33. The arrows A32 and A33 correspond to the same one scanning operation of the printhead 24. Since the orifice array 33K is located on the downstream side of the backward path with respect to the orifice array 33RCT, the pattern 1211 of the color ink is printed before the pattern 1212 of the reaction liquid. However, since the uniform pattern 1213 of the reaction liquid is formed as an underlying pattern in the forward path A31, the flow of the droplets of the color ink can be prevented.

Like the above-described first example, printing of the pattern 1211 and the like may sequentially be performed for each of the regions R1 to R3 but may be performed simultaneously. When simultaneously performing the printing for the regions R1 to R3, it can be said that the printing can be implemented by, for example, one reciprocal motion on the forward path indicated by the arrows A11, A12, and A31 and on the backward path indicated by the arrows A32 and A33.

### Third Example

According to the print mode Md1 (first example), on both the regions R1 and R2 (and the region R3), the pattern 1212 of the reaction liquid is printed before the pattern 1211 of the color ink, that is, the pattern 1212 is formed under the pattern 1211.

However, since the pattern 1212 of the reaction liquid has a relatively high dot density in the region Sr2, depending on the type of the print medium P, the droplets of the reaction liquid may flow on the print medium P before the pattern 1211 of the color ink is printed.

Hence, the uniform pattern 1213 of the reaction liquid may further be printed in the region R1 (and the region R3). That is, in the sub-pattern 137 shown in FIG. 11, the pattern 1213 may be formed in all the regions R1 to R3. The pattern 1213 thus further functions as an underlying pattern that prevents the flow of the droplets of the reaction liquid in the pattern 1212.

In the following explanation, the adjustment pattern print mode will be defined as a third print mode Md3.

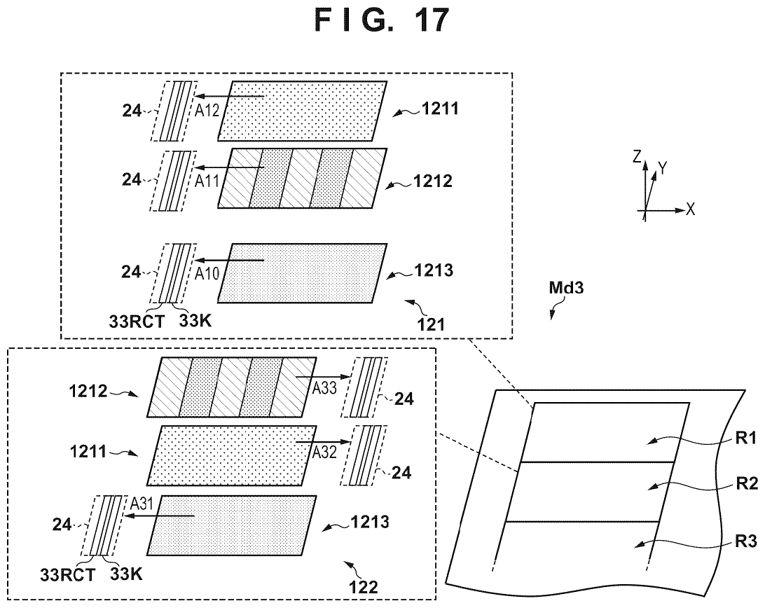

FIG. 17 is a schematic perspective view for individually explaining the adjustment pattern 121 for forward path printed in the region R1 in the print mode Md3 and the adjustment pattern 122 for backward path printed in the region R2, like the above-described first and second examples (see FIGS. 14 and 16).

In the print mode Md3, for the region R1, the patterns 1212 and 1211 are printed in the forward path of the printhead 24 indicated by the arrows A11 and A12. However, in the preceding forward path, the pattern 1213 is printed, as indicated by an arrow A10. This also applies to the region R3. The region R2 is the same as in the second example, and a description thereof will be omitted here.

Like the above-described first and second examples, printing of the pattern 1211 and the like may sequentially be performed for each of the regions R1 to R3 but may be performed simultaneously. When simultaneously performing the printing for the regions R1 to R3, it can be said that the printing can be implemented by, for example, a 1.5 reciprocal motion on the forward path indicated by the arrows A10 and A31, on the backward path indicated by the arrows A32 and A33, and on the forward path indicated by the arrows A11 and A12.

### First Embodiment

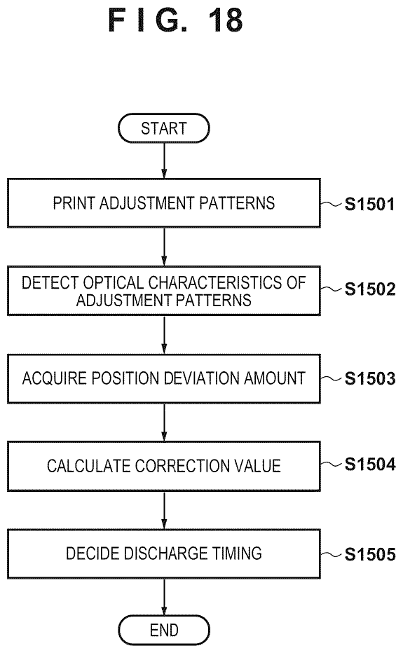

FIG. 18 shows a flowchart of acquisition processing for acquiring the position deviation amount of a reaction liquid between a forward path and a backward path based on one of the first to third examples (for example, an adjustment pattern printed in a print mode Md3). A series of processes shown in this flowchart can be performed by a CPU 102 deploying, on a RAM 106, a corresponding program read out from a ROM 104 and executing the program, and some/all of the processes may be executed by a semiconductor integrated circuit such as an ASIC. That is, functions to be described here can be implemented by either hardware or software.

In step S1501 (to be simply referred to as “S1501” hereinafter, and this applies to the remaining steps to be described later), the CPU 102 reads out corresponding image data from a memory 108 and prints adjustment patterns 121 and 122.

In S1502, the CPU 102 detects the optical characteristic of each of the printed adjustment patterns. Detection of the optical characteristic is performed based on the reflection intensities of adjustment patterns 101 and 102 detected by an optical sensor 200 (se FIGS. 8 and 9). Detection of the optical characteristic may be performed by visual observation of the user, and in this case, this step is omitted.

In S1503, the CPU 102 acquires the position deviation amount of the reaction liquid between the forward path and the backward path based the acquired optical characteristics of the adjustment patterns (see FIG. 9).

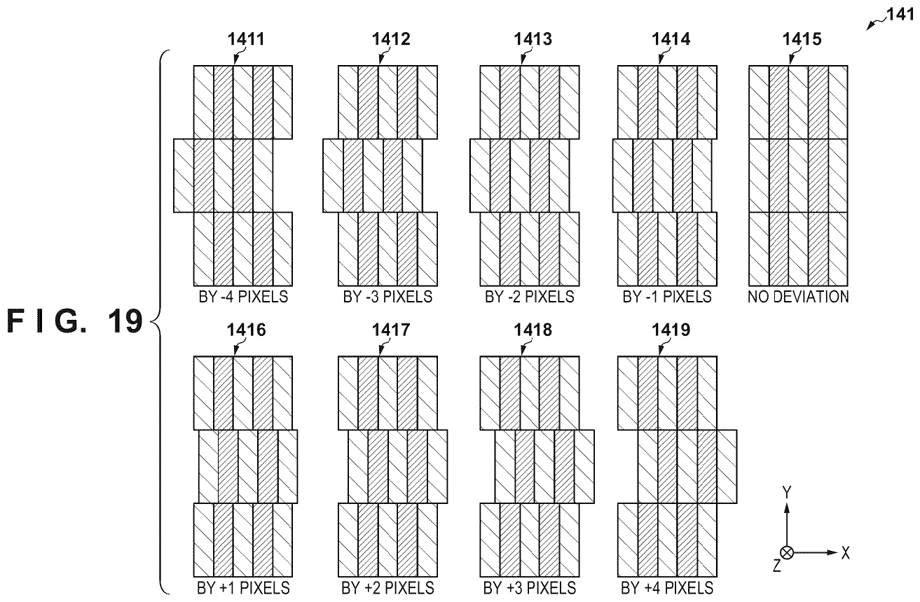

In S1504, based on the acquired position deviation amount, the CPU 102 calculates a correction value for correcting the discharge timing of the reaction liquid (see FIG. 19).

In S1505, the CPU 102 decides the discharge timing of the reaction liquid based on the calculated correction value, thereby making it possible to discharge the reaction liquid to an appropriately position.

FIG. 19 shows examples of an adjustment pattern 141 each printed based on one of the first to third examples. In this example, the adjustment pattern 141 includes nine adjustment patterns 1411 to 1419. The adjustment patterns 1411 to 1419 are formed such that the X-direction deviation amount of the adjustment pattern 122 for backward path printed in the region R2 with respect to the adjustment pattern 121 for forward path printed in the regions R1 and R3 changes while increasing by one pixel. That is:

in the adjustment pattern 1411, the adjustment pattern 122 is deviated by four pixels (−4 pixels) in the −X direction with respect to the adjustment pattern 121;

in the adjustment pattern 1412, the adjustment pattern 122 is deviated by three pixels (−3 pixels) in the −X direction with respect to the adjustment pattern 121;

in the adjustment pattern 1413, the adjustment pattern 122 is deviated by two pixels (−2 pixels) in the −X direction with respect to the adjustment pattern 121;

in the adjustment pattern 1414, the adjustment pattern 122 is deviated by one pixel (−1 pixel) in the −X direction with respect to the adjustment pattern 121;

in the adjustment pattern 1415, the adjustment pattern 122 is not deviated in the X direction with respect to the adjustment pattern 121, that is, the adjustment patterns match each other in the X direction (there is no deviation);

in the adjustment pattern 1416, the adjustment pattern 122 is deviated by one pixel (+1 pixel) in the +X direction with respect to the adjustment pattern 121;

in the adjustment pattern 1417, the adjustment pattern 122 is deviated by two pixels (+2 pixels) in the +X direction with respect to the adjustment pattern 121;

in the adjustment pattern 1418, the adjustment pattern 122 is deviated by three pixels (+3 pixels) in the +X direction with respect to the adjustment pattern 121; and

in the adjustment pattern 1419, the adjustment pattern 122 is deviated by four pixels (+4 pixels) in the +X direction with respect to the adjustment pattern 121.

In the adjustment pattern 1415, between adjustment patterns 124 and 126, regions Sr1 (or Sr2) match each other in the X direction and are located on one line in the Y direction. On the other hand, for the remaining adjustment patterns (for example, the adjustment pattern 1411), between the adjustment patterns 124 and 126, the regions Sr1 (or Sr2) do not match each other in the X direction.

Note that in the example shown in FIG. 19, the X-direction deviation amount between the adjustment pattern 121 and the adjustment pattern 122 increases by one pixel between the adjustment patterns 1411 to 1419. However, the change amount of the deviation amount is not limited to this example.

According to the adjustment pattern 141, it is possible to evaluate the deviation of the discharge position of the reaction liquid in the backward path (scanning in the +X direction) with respect to the discharge position of the reaction liquid in the forward path (scanning in the −X direction). For example, there is substantially no position deviation, in the adjustment pattern 1415, the regions Sr1 match each other in the X direction between the adjustment patterns 121 and 122.

On the other hand, if a position deviation occurs, in the adjustment

patterns other than the adjustment pattern 1415, that is, in the adjustment patterns 1411 to 1414 and 1416 to 1419, the regions Sr1 match each other in the X direction between the adjustment patterns 121 and 122.

For example, if the position deviation amount is +3 pixels, in the adjustment pattern 1412 in which the position deviation amount is originally −3 pixels, the regions Sr1 match each other between the adjustment patterns 121 and 122. In this case, a correction value corresponding to −3 pixels is obtained, the discharge timing in the backward path is corrected, and the discharge position is corrected by three pixels in the −X direction.

In the above-described way, the relative deviation amount of the discharge position of the reaction liquid between the forward path and the backward path can be acquired, based on the printing result of the adjustment pattern 141, and the correction value for correcting the position deviation can be calculated.

### Second Embodiment

When printing an adjustment pattern 141, print modes Md1 to Md3 described above are selected as needed, and can be selected mainly based on the type of a print medium P. Here, it is assumed that the print modes Md1 and Md3 are selected, but the print mode Md2 may be combined as another embodiment, or another equivalent print mode may further be combined.

The print modes Md1 and Md3 will be compared here. In the print mode Md3, for example, the consumption amount of the reaction liquid is large. For this reason, the print mode Md1 is selected as a standard, but the print mode Md3 may be selected if the position deviation amount of the reaction liquid is difficult to evaluate in the print mode Md1.

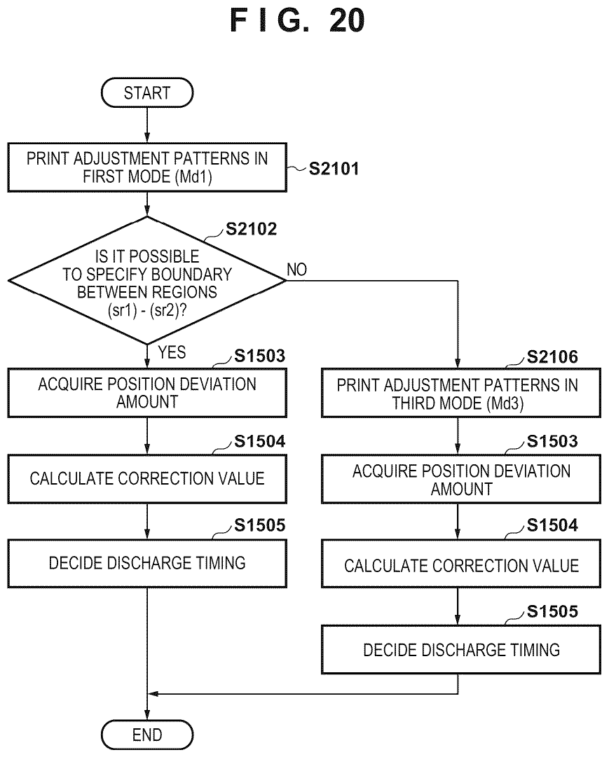

FIG. 20 shows a flowchart of acquisition processing according to the second embodiment. Steps exemplified here are the same as in the above-described first embodiment (see FIG. 18) except S2101, S2102, and S2106, and a description thereof will be omitted.

In S2101, a CPU 102 prints adjustment patterns 121 and 122 in the print mode Md1.

In S2102, the CPU 102 detects the optical characteristics of the printed adjustment patterns (see FIGS. 8 and 9), and determines, based on the detection result, whether a change of the reflection intensity between regions Sr1 and Sr2 can be specified (whether the boundary between the regions Sr1 and Sr2 can be specified). For example, if the boundary between the regions Sr1 and Sr2 is unclear, the change rate of the reflection intensity is moderate and, therefore, this step is performed based on whether the change rate of the reflection intensity satisfies a criterion. Note that this step is implemented by detection of an optical sensor 200 but may be performed by visual observation of the user.

If the change of the reflection intensity between the regions Sr1 and Sr2 can be specified, the process advances to S1503, and otherwise, the process advances to S2106.

In S2106, the CPU 102 prints adjustment patterns 121 and 122 in the print mode Md3 and then advances to S1503.

According to this embodiment, the same effects as in the first embodiment can be obtained, and additionally, since the adjustment patterns are printed in the print mode Md3 only when necessary, it is advantageous in avoiding unnecessary consumption of the reaction liquid.

### Third Embodiment

Even if the type of a print medium P is specified in advance, and print modes Md1 and Md3 are selected based on this, an adjustment pattern 141 may not be printed as intended. Hence, it may be difficult for the user to select the print modes Md1 and Md3 in advance. In this case, a predetermined test pattern is printed before printing of the adjustment pattern 141, and this makes it possible to easily be evaluate which one of the print modes Md1 and Md3 should be selected.

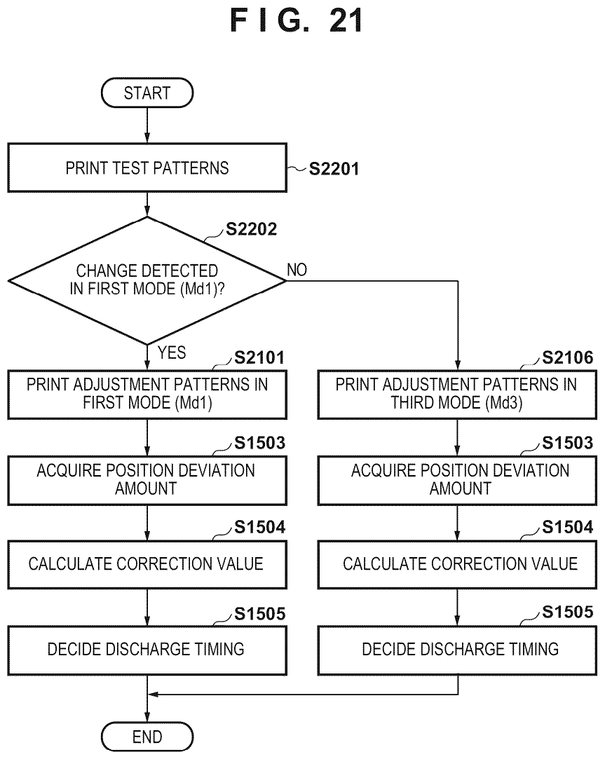

FIG. 21 shows a flowchart of acquisition processing according to the third embodiment. Steps exemplified here are the same as in the above-described second embodiment (see FIG. 20) except S2201 and S2202, and a description thereof will be omitted.

In S2201, a CPU 102 prints sub-patterns 61 and 62 shown in FIGS. 6A and 6B as test patterns in place of the adjustment pattern 141 in each of the print modes Md1 and Md3.

In S2202, the CPU 102 detects the optical characteristics of the printed test patterns (see FIGS. 8 and 9), and determines, based on the test patterns printed in the print mode Md1, whether a change of the reflection intensity between regions Sr1 and Sr2 can be specified. This determination is performed in accordance with the same procedure as S2102, that is, performed based on whether the change rate of the reflection intensity satisfies a criterion. Note that this step is implemented by detection of an optical sensor 200 but may be performed by visual observation of the user.

If the change of the reflection intensity between the regions Sr1 and Sr2 can be specified, the process advances to S2101, and otherwise, the process advances to S2106.

That is, according to this embodiment, it is specified, based on the test patterns printed in advance, whether the adjustment pattern 141 should be printed in the print mode Md1 or in the print mode Md3. The print mode Md1 or Md3 is selected based on the specifying result. Even if the type of the print medium P is specified in advance, the adjustment pattern 141 may not be printed as intended. Hence, according to this embodiment, it is possible to appropriately print the adjustment pattern 141 even in such a case.

According to this embodiment, since the adjustment pattern 141 is printed in the print mode Md1 or Md3 corresponding to the type of the print medium P, the adjustment pattern 141 is never unnecessarily printed in a non-corresponding print mode. Hence, according to this embodiment, the same effects as in the above-described first and second embodiments can be obtained, and additionally, it is advantageous in avoiding unnecessary consumption of the reaction liquid.

In this embodiment, an orifice array 33RCT capable of discharging the reaction liquid is arranged on the downstream side in the forward path of a printhead 24 with respect to an orifice array (for example, an orifice array 33K) capable of discharging a color ink. If the print medium P is, for example, a non-absorbing (or hardly absorbing) print medium, and is of a type (for example, synthetic paper) on which ink readily wet-spreads, the adjustment pattern 141 is formed in one of the print modes Md2 and Md3 shown in FIGS. 16 and 17. That is, for the forward path and the backward path of the printhead 24, adjustment patterns 121 and 122 obtained by overlaying the adjustment pattern of the reaction liquid and the adjustment pattern of the color ink are formed. Here, when forming the adjustment pattern 122 in the backward path, in the preceding forward path, a pattern 1213 (sub-pattern 137) is further formed as an underlying pattern by the orifice array 33RCT. When the underlying pattern is formed in advance, the flow of droplets of the color ink in an adjustment pattern 125 (pattern 1211) can be prevented. After that, the position deviation of the reaction liquid can appropriately be visualized by an adjustment pattern 126 of the reaction liquid, which is further formed after that.

On the other hand, if the print medium P is, for example, a non-absorbing (or hardly absorbing) print medium, and is of a type (for example, gloss vinyl chloride film) on which ink hardly wet-spreads, the adjustment pattern 141 is formed in the print mode Md1 shown in FIG. 14. That is, in the forward path, an adjustment pattern 124 (pattern 1212) of the reaction liquid and an adjustment pattern 123 (pattern 1211) of the color ink are formed in an overlaid state, thereby forming the adjustment pattern 121. On the other hand, in the backward path, the adjustment pattern 126 (pattern 1212) of the reaction liquid, which is a part of the adjustment pattern 122, is formed, and in the next forward path, the adjustment pattern 125 (pattern 1211) of the color ink, which is another part, is formed.

According to the forming method of the adjustment pattern 141, the position deviation of discharge of the reaction liquid between the forward path and the backward path can be evaluated, and the driving timing of the orifice array 33RCT can appropriately be corrected.

In the embodiment, the moving direction of the printhead 24 in which the orifice array 33RCT is located on the downstream side with respect to another orifice array 33 (for example, the orifice array 33K) capable of discharging a color ink is defined as the forward path, and the opposite direction is defined as the backward path. However, the forward path and the backward path may be replaced. Some adjustment patterns are each formed by a plurality of sub-patterns. However, each sub-pattern may be expressed as an adjustment pattern, and various kinds of patterns may be expressed by other equivalent names.

### Program

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

### Others

In the above explanation, the printing apparatus 10 using the inkjet printing method has been described as an example. However, the printing method is not limited to the above-described mode. The printing apparatus 10 may be a single-function printer having only a printing function or may be a multi-function printer having a plurality of functions such as a printing function, a FAX function, and a scanner function. Also, for example, the printing apparatus may be a manufacturing apparatus configured to manufacture a color filter, an electronic device, an optical device, a microstructure, or the like by a predetermined printing method.

Also, “print” in this specification should be interpreted in a broader sense. Hence, the mode of “print” is usable regardless of whether a target formed on a print medium is significant information such as a character or graphic pattern and also regardless of whether the information is made to be visually perceivable to humans.

“Print media” should also be interpreted in a broader sense, like “print”. Hence, the concept of “print media” can include not only paper used in general but also any members capable of accepting ink, including fabrics, plastic films, metal plates, glass, ceramic, resins, wood, and leather materials.

Also, in the embodiments, each element is named using an expression based on its main function. However, each function described in the embodiments may be a sub-function, and is not strictly limited to the expression. The expression can be replaced with a similar expression. In the same vein, an expression “unit or portion” can be replaced with “tool”, “component”, “member”, “structure”, “assembly”, or the like. Alternatively, these may be omitted or added. Expressions “first”, “second, and the like in the description of the embodiments are added for the sake of discrimination of elements, and do not indicate priority or importance.

In addition, two or more elements selectably exemplified in the embodiments are not strictly limited to the exemplification, and may arbitrarily be combined. For example, each of the two or more elements exemplified may be additionally selected or alternatively selected. As an example, when arbitrarily combining two elements A and B, to indicate one of “only A”, “only B”, and “both A and B”, an expression “A and/or B” may be used, or an expression “at least one of A and B” may be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-013299, filed Jan. 31, 2024, which is hereby incorporated by reference herein in its entirety.

What is claimed is:

1. A printing apparatus comprising:
a printhead including a first nozzle array and a second nozzle array; and
a print control unit configured to perform printing on a print medium by driving the printhead while reciprocally moving the printhead as a serial head, wherein
the first nozzle array is configured to discharge a color ink,
the second nozzle array is configured to discharge a reaction liquid that reacts with the color ink and fixes the color ink on the print medium, and
when a moving direction of the printhead in which the second nozzle array is located on a downstream side with respect to the first nozzle array is defined as a forward path, and an opposite direction is defined as a backward path,
the print control unit executes first drive control of driving the printhead such that
for each of the forward path and the backward path of the printhead, an adjustment pattern that is configured to adjust a discharge position and is formed by overlaying a pattern of the reaction liquid and a pattern of the color ink is formed, and
when forming the adjustment pattern in the backward path of the printhead, an underlying pattern is further formed by the second nozzle array in a preceding forward path.

2. The apparatus according to claim 1, wherein
the print control unit can further execute second drive control of driving the printhead such that
in the forward path of the printhead, the adjustment pattern is formed, and
in the backward path of the printhead, the pattern of the reaction liquid, which is a part of the adjustment pattern, is formed, and in a next forward path, the pattern of the color ink, which is another part of the adjustment pattern, is formed.

3. The apparatus according to claim 2, further comprising a specifying unit configured to specify a type of the print medium,
wherein the print control unit selectively performs the first drive control and the second drive control based on a specifying result of the specifying unit.

4. The apparatus according to claim 3, wherein
the print control unit drives the printhead to form not less than two test patterns for evaluating which one of the first drive control and the second drive control should be used to form the adjustment pattern, and
the specifying unit performs the specifying based on the not less than two test patterns.

5. The apparatus according to claim 1, wherein
in the adjustment patterns,
the pattern of the color ink is a uniform pattern, and
the pattern of the reaction liquid is a pattern formed by alternately forming not less than two patterns having different dot densities.

6. The apparatus according to claim 5, wherein
the underlying pattern is another uniform pattern different from the uniform pattern of the color ink.

7. The apparatus according to claim 5, wherein
the adjustment pattern is one of a plurality of adjustment patterns, and
positions of the not less than two alternately formed patterns are different from each other in a direction of reciprocal movement of the printhead between the plurality of adjustment patterns.

8. The apparatus according to claim 1, further comprising a reading unit configured to read the adjustment pattern,
wherein the print control unit corrects a driving timing of the second nozzle array based on a read result of the reading unit.

9. The apparatus according to claim 1, wherein
if a region through which the first nozzle array and the second nozzle array pass by reciprocal movement of the printhead is divided into a first region and a second region in a direction crossing a direction of the reciprocal movement,
the print control unit
executes the first drive control such that,
for the first region, the adjustment pattern is formed in the forward path of the printhead, and for the second region, the adjustment pattern is formed in the backward path of the printhead.

10. A control method of a printing apparatus including a printhead including a first nozzle array and a second nozzle array, and a print control unit configured to perform printing on a print medium by driving the printhead while reciprocally moving the printhead as a serial head, wherein
the first nozzle array is configured to discharge a color ink,
the second nozzle array is configured to discharge a reaction liquid that reacts with the color ink and fixes the color ink on the print medium, and
when a moving direction of the printhead in which the second nozzle array is located on a downstream side with respect to the first nozzle array is defined as a forward path, and an opposite direction is defined as a backward path, the control method comprises:
for each of the forward path and the backward path of the printhead, forming an adjustment pattern that is configured to adjust a discharge position and is formed by overlaying a pattern of the reaction liquid and a pattern of the color ink; and
when forming the adjustment pattern in the backward path of the printhead, further forming an underlying pattern by the second nozzle array in a preceding forward path.
